(19) United States
(12) Patent Application Publication
(10) Pub. No.: US 2017/0011662 A1
(43) Pub. Date: Jan. 12, 2017

(54) OVERLAY KITS FOR CUSTOMIZING INSTRUMENT FACES ON GAUGES, METERS AND THE LIKE

(71) Applicants: Anthony Manos, Frankfort, IL (US); Jennifer Molski, Frankfort, IL (US)

(72) Inventors: Anthony Manos, Frankfort, IL (US); Jennifer Molski, Frankfort, IL (US)

(21) Appl. No.: 14/792,765

(22) Filed: Jul. 7, 2015

(51) Int. Cl. G09F 3/02; G09F 3/10

(52) U.S. Cl. CPC G09F 3/02; G09F 3/10; G09F 2003/0266

(57) ABSTRACT

A system, kit and method for customizing analog instrument gauges and the like for manufacturing systems or other processes. Preferred kits include several sheets of precut polymeric circles removably adhered to a substrate. Each kit would contain a plurality of different-colored and different-sized circles which can be cut into sections, peeled from the substrate and applied to a gauge display. The polymeric material, preferably vinyl, is transparent to allow reading of the covered gauge face (e.g., a numbered scale). The color-coded sections can be used to indicate, for example, “good,” “fair,” and “bad” operating parameters.

### TECHNICAL FIELD OF THE INVENTION

The present invention relates to methods of preparing custom overlays for display faces on analog type gauges, meters, tubing, cylinders, clocks and the like. Specifically, the invention relates to a method for customizing analog gauges, meters and the like with coded overlays.

### BACKGROUND OF THE INVENTION

In almost every manufacturing facility, regardless of the product of manufacture, it is typically at least one workers job to monitor, look at, read and/or set gauges related to a status or condition of a process parameter such as time, volume, temperature, pressure, liquid level (e.g., remaining liquid, how full, how high, how empty, how low, etc.), mass, speed, etc. However, some of these system gauges—the term “gauge” is intended to be inclusive of all analog-type instruments which are used for indicating or setting a measurable parameter including clocks (indication of time or duration), fill-gauges (e.g., volume or fluid level), and dials (e.g., used to pre-set maximum and minimums)—are difficult to quickly and clearly read due to being positioned at a distance from an operator or having a very small type-face or scale.

Often the gauge is not used to indicate an exact number, but merely to show operation is occurring within an acceptable range. For such situations, gauges can be made with colored (or otherwise coded) zones to indicate, for example, green to indicate operation is within an “acceptable/preferred” range, yellow to show a “caution” range, and red for a “critical/danger” range. In some cases manufacturers are able to have a customized dial face or crystal (cover) made with bold colors to indicate the desired ranges. However,these customized gauges are not easily altered and in some processes the manufacturing parameters can change, both over time and as different products are run. For example, a first product may require a greater temperature or pressure than a second product during manufacture, while a third product has less mass at completion. If these three hypothetical products are made using the same equipment, an operator may be misled by a custom gauge made for only one product.

Until the invention of the present application, these and other problems in the prior art went either unnoticed or unsolved by those skilled in the art. The present invention provides unique, simple and economical methods and systems for customizing gauges without sacrificing accuracy, durability or effectiveness.

### SUMMARY OF THE INVENTION

There is disclosed herein a system, instrument, customizing kit and method for customizing analog instrument gauges, each of which overcomes disadvantage of existing systems, instruments and methods while affording additional operating advantages.

Generally speaking, a kit for customizing an analog gauge face comprises a plurality of sheet or substrates having sets of removable gauge markers thereon, a container configured to retain the plurality of sheets, and instructions on how to use the removable gauge markers for customizing a gauge. The sets of removable gauge markers comprise precut circles of a polymeric material, preferably vinyl.

In an embodiment, each set of removable gauge markers comprises at least two precut circles having different diameters. In a most preferred embodiment, each set comprises circles of three different diameters. Further, each set of removable gauge markers is coded to be visually distinguishable from other sets. For example, the markers may be color-coded, lined or shaded to distinguish gauge zones when applied. Finally, in a specific embodiment, at least some of the precut circles will comprise an outer ring section and an inner core section.

In a preferred method for customizing an instrument gauge, the steps comprise obtaining a plurality of precut polymeric circles attached to a substrate, selecting a first precut polymeric circle from the plurality of polymeric circles, cutting the selected first precut polymeric circle to obtain a first overlay portion, peeling the first overlay portion from the substrate, and applying the first overlay portion to the instrument gauge. Of course, where multiple distinct zones are needed to be differentiated, the selecting, cutting, peeling and applying steps may be repeated for creating additional and distinct overlays.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a front view of an embodiment of the gauge marker kit;

FIG. 2 is a plan view of one embodiment of a sheet of polymeric gauge markers; and

FIG. 3 is an illustration of multiple possible customization patterns for an analog gauge.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

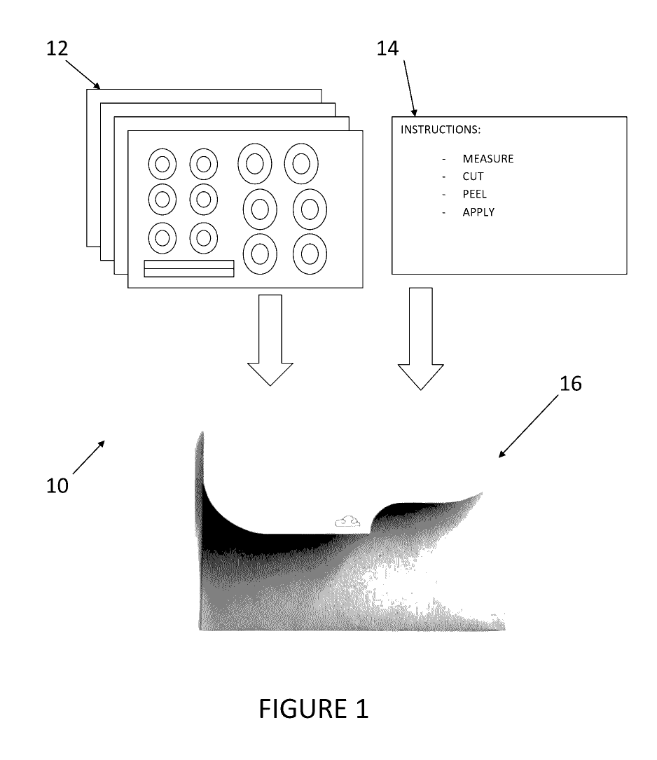

Referring to FIG. 1, there is illustrated an embodiment of gauge marker kit, generally designated by the numeral 10. The particular illustrated kit 10 is for an analog gauge. In fact, while all the majority of embodiments illustrated are directed to a round-faced, dial-type gauge, it should be understood that the principles of the invention can be more broadly applied to other instruments as well. Herein, the term “gauge” is used broadly to include round gauges (as shown), clocks, timers, float gauges, fill-tubes, column-type gauges, semi-circular gauges, tube-type gauges and the like.

As can be seen in FIG. 1, the preferred kit 10 is comprised of a plurality of sheets 12, an instruction sheet 14, and a pouch or container 16 for retaining the sheets and instructions. The container 16 is preferably made of plastic to resist water, dust, dirt, etc., all of which can be in abundance in an industrial setting. A flap is preferable to help protect the materials stored inside.

While not specifically set forth in the numerous drawing figures, a gauge marking system may be comprised of a single sheet 12 and instructions. The system sheet may be embodied in any combination of the myriad of forms described for the preferred kit 10.

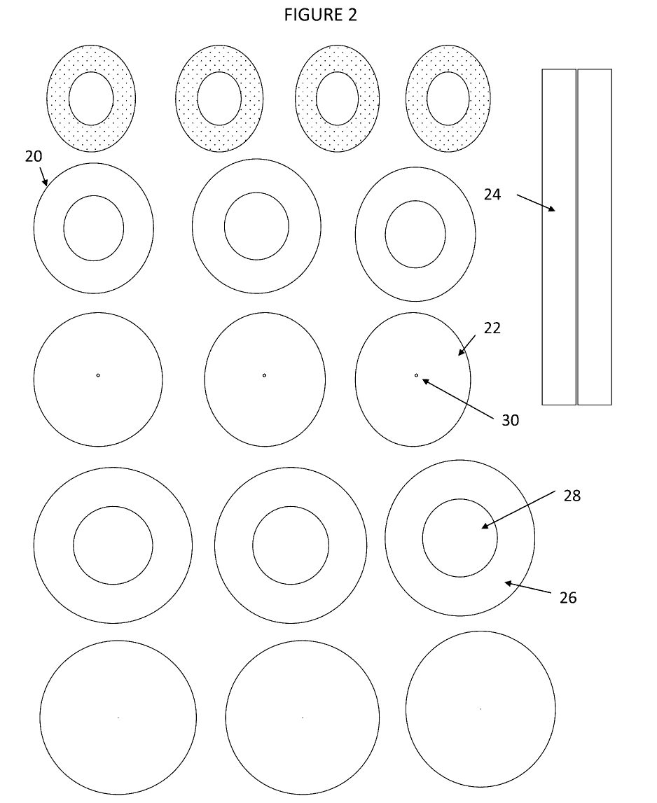

For example, FIG. 2 illustrates one possible layout for sheet 12 of gauge marker 20 which may be used in a simpler single sheet embodiment of the invention. The sheet 12 is preferably comprised of standard paper backing, while the gauge markers are preferably a polymeric material, most preferably vinyl. One side of the polymeric material is preferably coated with an adhesive. The adhesive used is preferably rated at 4-5 year outdoor, which allows adherence to a surface for an extended period. The markers 20 may be precut from the adhesive-backed material after mating with the paper backing. A release material is used on the paper-backing to allow easy removal of the pre-cut shapes.

In an alternate embodiment, the markers may take advantage of the vinyl material's tendency to “cling” to glass and plastic surfaces (i.e., gauge covers). In such an embodiment, no adhesive layer may be needed. This may allow the markers to be temporarily removed from a gauge to clean the application surface, and then replaced or reused, as desired.

The polymeric material used should be transparent to allow reading gauge face markings, as necessary. Also, it is preferred to include at least two different colors of markers 20, most preferably three colors, as part of each kit 10. While Red and Green are the most common colors used, there are no limits to the color combinations possible. Alternatively, the markers 20 may be printed with a pattern or by some other marking to distinguish zones on a custom gauge.

As shown in FIG. 2, a sheet 12 may include three sets of different sized, precut, polymeric markers 20. These illustrated markers include a solid circle marker 22, strips 24, and concentric markers which consist of at least one ring section 26 and a center core section 28. Additional ring sections can be made by precutting additional sections from either the ring section 26 or the core section 28. A center point 30 may be marked on each circle to help centering placement on gauges, as explained below.

To customize a gauge, the appropriate sized polymeric marker 20 must first be selected. This can be done in many ways, including by measuring the gauge face and markers 20 to determine the best fit, or by merely holding the sheet 12 up to the gauge face and selecting the best fit marker 20. The solid circle 22, strip 24 or ring section 26 (or core section 28) can be cut directly on the substrate/sheet 12 into a desired arc or strip overlay section 32. Once cut, the resulting overlay section 32 can be peeled from the sheet 12 and applied to the appropriate portion of the desired gauge.

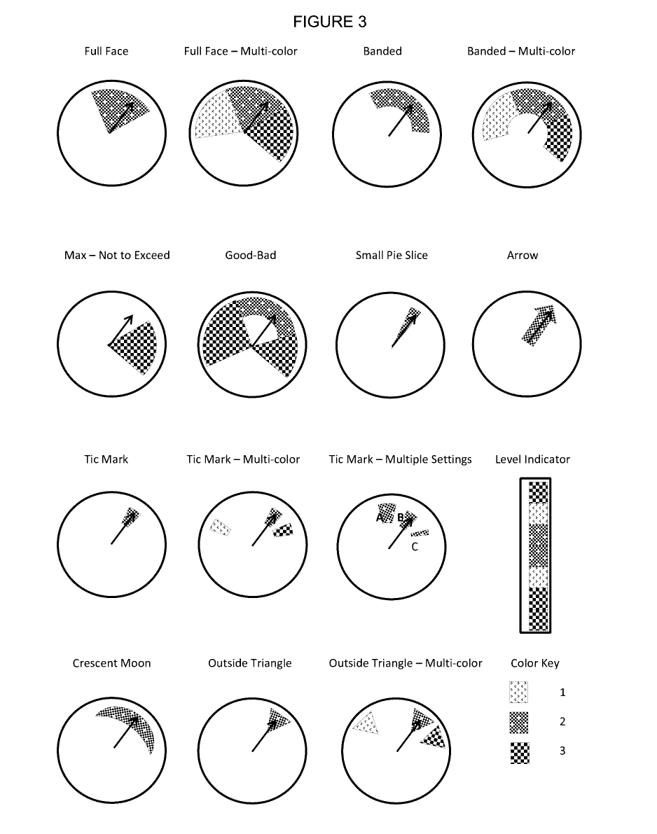

FIG. 3 illustrates some of the more common overlay 32 arrangements. Numerous alternate arrangements can also be configured with the inventive gauge kit 10. In the preferred adhesive-backed overlays 32, removal typically destroys the overlay, preventing reuse. However, in the alternate cling-form embodiment (i.e., no adhesive), configurations can be removed and moved with ease and re-applied as desired. Removed overlays 32 need not be thrown out either, as they can be re-adhered to the sheet 12 in many instances and stored in the pouch 16 for later use.

As an optional feature of the adhesive-backed embodiment, a clear and colorless shield or guard layer (not shown) made from a vinyl material that clings may be placed over the overlays 32 to protect them from dirt, grease, debris, etc. The shield layer could be easily removed, cleaned and returned, or merely replaced regularly. In this way, the gauge covers are kept clean and readable.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A kit for customizing an analog gauge face, the kit comprising:
a first sheet having a first set of removable gauge markers thereon;
a second sheet having a second set of removable gauge markers thereon;
a third sheet having a third set of removable gauge markers thereon;
a container configured to retain the first, second and third sheets; and
instructions on how to use the removable gauge markers for customizing a gauge;
wherein the first, second and third sets of removable gauge markers comprise precut circles of a polymeric material.

2. The kit of claim 1, wherein the first, second and third set of removable gauge markers each comprises at least two precut circles having different diameters.

3. The kit of claim 1, wherein the first, second and third set of removable gauge markers are coded to be visually distinguishable.

4. The kit of claim 3, wherein the removable gauge markers are color-coded.

5. The kit of claim 4, wherein the color-coded removable gauge markers are transparent.

6. The kit of claim 1, wherein the first, second and third sets of removable gauge markers comprise an adhesive layer applied to a first surface of the gauge marker.

7. The kit of claim 4, wherein the first, second and third sets of removable gauge markers further comprise precut strips of a polymeric material.

8. The kit of claim 1, further comprising a plurality of sheets of customizable polymeric material.

9. The kit of claim 2, wherein each of the precut circles comprises an outer ring section and an inner core section.

10. A customizable gauge marking system comprising:
a first sheet;
a first set of gauge markers removably adhered to the first sheet, the gauge markers comprising at least two precut circles having different diameters; and
instructions on how to use the gauge markers for customizing a gauge;
wherein the first set of gauge markers comprises precut circles of a polymeric material having a first side for adhering to a surface of a gauge.

11. The customizable gauge marking system of claim 10, wherein the first side comprises an adhesive.

12. The customizable gauge marking system of claim 10, further comprising a second sheet having a second set of removable gauge markers thereon.

13. The customizable gauge marking system of claim 12, further comprising a third sheet having a third set of removable gauge markers thereon.

14. The customizable gauge marking system of claim 13, further comprising a container configured to retain the first, second and third sheets, and wherein the second and third set of gauge markers comprise precut circles of polymeric material.

15. The customizable gauge marking system of claim 13, wherein the second and third set of removable gauge markers each comprises at least two precut circles having different diameters.

16. The customizable gauge marking system of claim 13, wherein the first, second and third set of removable gauge markers are coded to be visually distinguishable.

17. The customizable gauge marking system of claim 16, wherein the removable gauge markers are color-coded.

18. The customizable gauge marking system of claim 17, wherein the color-coded removable gauge markers are transparent.

19. The customizable gauge marking system claim 13, wherein the second and third sets of removable gauge markers further comprise precut strips of a polymeric material.

20. The customizable gauge marking system of claim 15, wherein each of the precut circles comprises an outer ring section and an inner core section.

21. A method for customizing an instrument gauge comprising the steps of:
obtaining a plurality of precut polymeric circles attached to a substrate;
selecting a first precut polymeric circle from the plurality of polymeric circles;
cutting the selected first precut polymeric circle to obtain a first overlay portion;
peeling the first overlay portion from the substrate;
applying the first overlay portion to the instrument gauge;

22. The method of claim 21, further comprising the steps of:
selecting an additional precut polymeric circle from the plurality of polymeric circles;
cutting the selected additional precut polymeric circle to obtain an additional overlay portions;
peeling the additional overlay portion from the substrate;
applying the additional overlay portion to the instrument gauge; and
repeating the selecting, cutting, peeling and applying steps for additional overlays, as needed.

23. The method of claim 21, wherein the plurality of precut polymeric circles are comprised of at least two different colors of circles.

24. The method of claim 21, wherein the plurality of precut polymeric circles are comprised of at least two different sizes of circles.

25. The method of claim 21, wherein the plurality of precut polymeric circles are comprised of at least two visually distinct circles.

26. The method of claim 22, wherein the plurality of precut polymeric circles are comprised of at least two different colors of circles.

27. The method of claim 22, wherein the plurality of precut polymeric circles are comprised of at least two different sizes of circles.

28. The method of claim 22, wherein the plurality of precut polymeric circles are comprised of at least two visually distinct circles.

29. The method of claim 21, further comprising the steps of:
removing first or additional overlay sections from an instrument gauge; and
reattaching the removed overlay to the substrate.

30. The method of claim 22, further comprising the steps of:
removing first or additional overlay sections from an instrument gauge; and
reattaching the removed overlay to the substrate.
